(19) United States
(12) Patent Application Publication
(10) Pub. No.: US 2022/0263663 A1
(43) Pub. Date: Aug. 18, 2022

(54) Digital Signature Method, Signature Information Authentication Method, And Relevant Electronic Devices

(71) Applicant: Beijing Baidu Netcom Science Technology Co., Ltd., Beijing (CN)

(72) Inventors: Yuao CHEN, Beijing (CN); Runyao DUAN, Beijing (CN)

(21) Appl. No.: 17/737,861

(22) Filed: May 5, 2022

(30) Foreign Application Priority Data
Jul. 20, 2021 (CN) 202110819116.8

(51) Int. Cl. H04L 9/32; H04L 9/08; H03M 7/30

(52) U.S. Cl. CPC H04L 9/3247; H03M 7/55; H04L 9/0858

(57) ABSTRACT

A digital signature method includes: obtaining a to-be-transmitted file, a private key and first compressed data, the first compressed data being obtained through compressing a symmetric tensor, the private key including a first invertible matrix; generating L pieces of second compressed data corresponding to L second symmetric tensors in accordance with the first invertible matrix and the first compressed data; creating a Hash value of a root node in a Hash tree in accordance with L pieces of created data, the L pieces of created data being the L pieces of second compressed data or the L second symmetric tensors; and generating signature information about the to-be-transmitted file for the first electronic device in accordance with the first character string, the first invertible matrix, the second invertible matrix, the L pieces of second compressed data and the Hash value of the root node in the Hash tree.

### CROSS-REFERENCE TO RELATED APPLICATION

This application claims a priority of the Chinese patent application No. 202110819116.8 filed on Jul. 20, 2021, which is incorporated herein by reference in its entirety.

### TECHNICAL FIELD

The present disclosure relates to the field of quantum computing technology, in particular to the field of information security in quantum computing, more particularly to a digital signature method, a signature information authentication method, and relevant electronic devices.

### BACKGROUND

Digital signature is a basic task in public key cryptography. The public key cryptography refers to that a password scheme includes a public key and a private key. The public key is disclosed to two users, so as to enable the two users to perform encryption and decryption as well as identity authentication in the case that no communication has been established therebetween. An object of the digital signature is to authenticate a file sender, so as to ensure that the file sender is true, which is important in e-business and an Internet protocol.

Currently, in the Internet communications, a commonly-used digital signature scheme is based on the difficulty in large integer factorization and discrete logarithm, e.g., an asymmetric cryptographic algorithm based on Diffie-Hellman key exchange.

### SUMMARY

An object of the present disclosure is to provide a digital signature method, a signature information authentication method, relevant devices, and relevant electronic devices.

In a first aspect, the present disclosure provides in some embodiments a digital signature method realized by a first electronic device, including: obtaining a to-be-transmitted file, a private key of the first electronic device for digital signature, and first compressed data, the first compressed data being obtained through compressing a randomly-generated symmetric tensor, an order of the first symmetric tensor being greater than 2, the private key including a first invertible matrix; generating L pieces of second compressed data corresponding to L second symmetric tensors in accordance with the first invertible matrix and the first compressed data, the L second symmetric tensors including the first symmetric tensor and symmetric tensors isomorphic to the first symmetric tensor, L being a positive integer greater than 1; performing digital signature on the to-be-transmitted file in accordance with a randomly-generated second invertible matrix and the first compressed data, so as to obtain a first character string; creating a Hash value of a root node in a Hash tree in accordance with L pieces of created data, the L pieces of created data being the L pieces of second compressed data or the L second symmetric tensors; and generating signature information about the to-be-transmitted file for the first electronic device in accordance with the first character string, the first invertible matrix, the second invertible matrix, the L pieces of second compressed data and the Hash value of the root node in the Hash tree.

In a second aspect, the present disclosure provides in some embodiments a signature information authentication method realized by a second electronic device, including: obtaining a to-be-transmitted file, signature information about the to-be-transmitted file, and a public key for authenticating the signature information for the second electronic device, the public key corresponding to a private key associated with the signature information, the public key including a Hash value of a root node in a Hash tree, the signature information including N pieces of second compressed data corresponding to N second symmetric tensors and authentication paths of N pieces of created data relative to the root node in the Hash tree, each piece of created data being one piece of second compressed data or a second symmetric tensor corresponding to one piece of second compressed data; generating Q second target character strings in accordance with the N pieces of second compressed data and the authentication paths, Q being a positive integer; in the case that the Hash value of the root node in the Hash tree is identical to each second target character string, performing matrix multiplication on the signature information and the N second symmetric tensors in accordance with the N pieces of second compressed data, so as to generate second signature data, the second signature data being a fourth symmetric tensor isomorphic to the N second symmetric tensors or fourth compressed data corresponding to the fourth symmetric tensor; performing digital signature on the to-be-transmitted file in accordance with the second signature data, so as to obtain a second character string; and authenticating the signature information in accordance with the second character string.

In a third aspect, the present disclosure provides in some embodiments a digital signature apparatus realized by a first electronic device, including: a first obtaining module configured to obtain a to-be-transmitted file, a private key of the first electronic device for digital signature, and first compressed data, the first compressed data being obtained through compressing a randomly-generated symmetric tensor, an order of the first symmetric tensor being greater than 2, the private key including a first invertible matrix; a first generation module configured to generate L pieces of second compressed data corresponding to L second symmetric tensors in accordance with the first invertible matrix and the first compressed data, the L second symmetric tensors including the first symmetric tensor and symmetric tensors isomorphic to the first symmetric tensor, L being a positive integer greater than 1; a first digital signature module configured to perform digital signature on the to-be-transmitted file in accordance with a randomly-generated second invertible matrix and the first compressed data, so as to obtain a first character string; a creation module configured to create a Hash value of a root node in a Hash tree in accordance with L pieces of created data, the L pieces of created data being the L pieces of second compressed data or the L second symmetric tensors; and a second generation module configured to generate signature information about the to-be-transmitted file for the first electronic device in accordance with the first character string, the first invertible matrix, the second invertible matrix, the L pieces of second compressed data and the Hash value of the root node in the Hash tree.

In a fourth aspect, the present disclosure provides in some embodiments a signature information authentication apparatus realized by a second electronic device, including: a second obtaining module configured to obtain a to-be-transmitted file, signature information about the to-be-transmitted file, and a public key for authenticating the signature information for the second electronic device, the public key corresponding to a private key associated with the signature information, the public key including a Hash value of a root node in a Hash tree, the signature information including N pieces of second compressed data corresponding to N second symmetric tensors and authentication paths of N pieces of created data relative to the root node in the Hash tree, each piece of created data being one piece of second compressed data or a second symmetric tensor corresponding to one piece of second compressed data; a fourth generation module configured to generate Q second target character strings in accordance with the N pieces of second compressed data and the authentication paths, Q being a positive integer; a matrix multiplication module configured to, in the case that the Hash value of the root node in the Hash tree is identical to each second target character string, perform matrix multiplication on the signature information and the N second symmetric tensors in accordance with the N pieces of second compressed data, so as to generate second signature data, the second signature data being a fourth symmetric tensor isomorphic to the N second symmetric tensors or fourth compressed data corresponding to the fourth symmetric tensor; a second digital signature module configured to perform digital signature on the to-be-transmitted file in accordance with the second signature data, so as to obtain a second character string; and an authentication module configured to authenticate the signature information in accordance with the second character string.

In a fifth aspect, the present disclosure provides in some embodiments an electronic device, including at least one processor, and a memory in communication with the at least one processor. The memory is configured to store therein an instruction to be executed by the at least one processor, and the instruction is executed by the at least one processor so as to implement the digital signature method in the first aspect or the signature information authentication method in the second aspect.

In a sixth aspect, the present disclosure provides in some embodiments a non-transitory computer-readable storage medium storing therein a computer instruction. The computer instruction is executed by a computer so as to implement the digital signature method in the first aspect or the signature information authentication method in the second aspect.

According to the embodiments of the present disclosure, it is able to solve the problem that the security of the digital signature is relatively low, i.e., to effectively improve the security of the digital signature.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings,

FIG. 1 is a flow chart of a digital signature method according to a first embodiment of the present disclosure;

FIG. 2 is a schematic view showing a computer-implemented authentication path of created data relative to a root node in a Hash tree;

FIG. 3 is a flow chart of a signature information authentication method according to a second embodiment of the present disclosure;

FIG. 4 is a schematic view showing a digital signature apparatus according to a third embodiment of the present disclosure;

FIG. 5 is a schematic view showing a signature information authentication apparatus according a fourth embodiment of the present disclosure; and

FIG. 6 is a block diagram of an electronic device according to one embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

First Embodiment

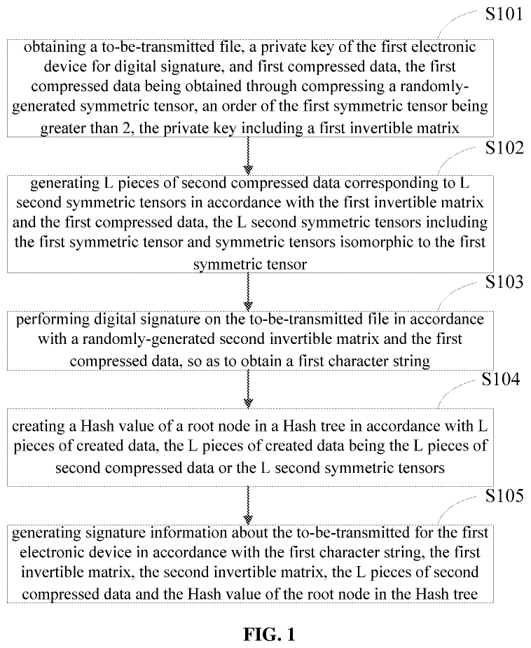

As shown in FIG. 1, the present disclosure provides in this embodiment a digital signature method realized by a first electronic device, which includes the following steps.

S101: obtaining a to-be-transmitted file, a private key of the first electronic device for digital signature, and first compressed data. The first compressed data is obtained through compressing a randomly-generated symmetric tensor, an order of the first symmetric tensor is greater than 2, and the private key includes a first invertible matrix.

In this embodiment of the present disclosure, the digital signature method relates to the field of quantum computing technology, in particular to the field of information security associated with quantum computing, and it may be widely applied in such scenarios as e-business, identity authentication and software distribution.

For example, in a scenario where identity authentication is to be performed, a first party needs to transmit a file to a second party, and the second party needs to authenticate that the file is transmitted by the first party rather than by the others. At this time, the first party may perform digital signature on the file. Upon the receipt of the file, corresponding signature information and a public key broadcast by the first party, the second party may authenticate that the file is transmitted by the first party.

For another example, in a scenario where soft distribution is to be performed, identity authentication may be performed on a publisher of obtained software, so as to determine a source of the software.

In actual use, the digital signature method in the embodiments of the present disclosure may be executed by a digital signature apparatus. The digital signature apparatus may be configured in the first electronic device so as to implement the digital signature method. The first electronic device may be a server or a terminal, which will not be particularly defined herein.

As a transmitting end, the first electronic device may communicate with the other electronic device, so as to transmit the file thereto. Before transmitting the file, the first electronic device may perform the digital signature on the to-be-transmitted file through a digital signature technology, so that the other electronic device authenticates that the received file is transmitted by the first electronic device and authenticates an identity of the transmitting end.

The to-be-transmitted file refers to a file to be transmitted by the first electronic device to the other electronic device, e.g., text, package, video or audio.

The private key may be pre-stored in the first electronic device, and used to encrypt the to-be-transmitted file and serve as a parameter for the digital signature. The private key may correspond to a public key, and a combination of the private key and the public key may be called as a key pair. Usually, the public key is broadcast by the first electronic device to the other electronic device(s), so that the other electronic device(s) authenticate(s) the signature information from the first electronic device using the public key.

As a task in public key cryptography, a digital signature scheme needs to be based on a difficulty in a certain algorithm problem, so as to ensure the security of the digital signature. Along with the development of a quantum computer, usually the algorithm problem for the existing digital signature scheme may not constitute a difficult problem to be solved by the quantum computer, i.e., it is impossible for the algorithm problem to counter an attack from the quantum computer, so the security of the digital signature is under threat.

The above-mentioned difficulty is a subtle concept. At first, different from a generally-accepted difficulty in a worst case, the difficulty here refers to a difficult in an average sense, i.e., there is no valid algorithm for most of input. Next, it is not all the difficult problems that correspond to an appropriate digital signature protocol, so a corresponding protocol needs to be designed with respect to each problem. Finally, the availability of the problem in post quantum cryptography needs to be discussed from the perspective of quantum algorithm design. For example, large integer factorization is difficult to a classical computer, but easy to the quantum computer.

In terms of computational complexity, as a relatively difficult problem in isomorphism-type problems, a tensor isomorphism problem will be described hereinafter.

p is set as a prime number, GF(p) represents a modular operation on a p domain, and GL(n, p) represents a set of invertible matrices having a size of n×n on GF(n, p). A multi-order matrix on GF(p) is called as a tensor, and an order of the tensor is usually greater than 2.

Taking a three-order matrix as an example, the tensor is called as a matrix having a size of n×n×n and includes n×n×n components, where n is the quantity of dimensions of the tensor. When a tensor is A represented by A=(aᵢⱼₖ) and another tensor is B represented by B=(bᵢⱼₖ), each order of data has length of n, i.e., subscripts i, j and k of the tensor respectively are 1 to n represented by i, j, k∈{1, 2, . . . , n}, aᵢⱼₖ, bᵢⱼₖ∈GF(p) represent elements in an ith slice, a jet row and a kth column of the two tensors, and these elements together form the tensors (aᵢⱼₖ) and (bᵢⱼₖ). The tensor isomorphism problem just refers to determining whether there is an invertible matrix, represented by C=(cᵢⱼ)∈GL(n, p), so that A=(C,C,C)° B. In other words, the tensor isomorphism problem refers to determining whether two tensors are isomorphic tensors, and in the case that the two tensors are isomorphic tensors, solving the invertible matrices mutually transformed between the two tensors.

In (C, C, C)° B, ° represents three matrices are multiplied by three directions of the tensor respectively, i.e., the three matrices are simultaneously multiplied by the three directions of the tensor, and the three matrices may be a same invertible matrix C. A result obtained after the multiplication is also a tensor represented by B′, where B′=(b′ᵢⱼₖ), b′ᵢⱼₖ is a number at a position corresponding to a subscript of the tensor B′, and b′ᵢⱼₖ=Σₒ₌₁ⁿcᵢₒ(Σ_{q=1}ⁿc_{jq}(Σᵥ₌₁ⁿcₖᵥbₒₚᵥ))=Σₒₚᵥcᵢₒc_{jq}cₖᵥb_{oqv}.

A symmetric tensor isomorphism problem follows the definition on the tensor isomorphism problem, with a difference in that the isomorphic tensors are symmetric tensors. In other words, in A=(C, C, C)° B, the tensors A and B are both symmetric tensors. The symmetric tensor is defined as that a tensor A meets aᵢⱼₖ=aᵢₖⱼ=aⱼᵢₖ=aⱼₖᵢ=a=ₖᵢⱼ=a ₖⱼᵢ.

From the perspective of quantum computing, due to the difficulty in solving the tensor isomorphism problem, it is able to ensure the security of the digital signature designed in accordance with the tensor isomorphism problem. When the two problems are solved through such an algorithm as Gröbner basis, data symmetry and relationality of the symmetric tensor are greater than those of the other tensor, and meanwhile the accuracy of an attach algorithm is low, so as compared with the tensor isomorphism problem, a convergence speed of solving the symmetric tensor isomorphism problem, i.e., determining whether the two symmetric tensors are isomorphic tensors and solving the invertible matrix mutually transformed between the two tensors in the case that the two symmetric tensors are isomorphic tensors, is smaller.

Hence, the security of the digital signature designed when the symmetric tensor isomorphism problem is used as the algorithm problem is higher than that designed when the tensor isomorphism problem is used. In the embodiments of the present disclosure, the symmetric tensor isomorphism problem is used as the algorithm problem, so as to design the digital signature on the basis of the difficulty in solving the symmetric isomorphism problem by most of the computers (including the quantum computer).

It should be appreciated that, the symmetric tensor isomorphism problem may also be evolved to a symmetric tensor which is a matrix with a higher order, i.e., the symmetric tensor isomorphism problem for the matrix with a higher order may be solved in accordance with the symmetric tensor isomorphism problem for a three-order matrix. For example, when two symmetric tensors are both four-order matrices represented by A=(aᵢⱼₖₗ) and B=(bᵢⱼₖₗ) respectively, the symmetric tensor isomorphism problem just refers to determining whether there is an invertible matrix C so that A=(C,C,C,C)° B.

For the symmetric tensor isomorphism problem, even if the two symmetric tensors are isomorphic tensors, it is still very difficult to solve the invertible matrix transformed between the two symmetric tensors. Hence, in order to ensure the security of the digital signature, the private key for the digital signature for the first electronic device may be set in a matrix form, so as to increase the difficulty in cracking the private key.

To be specific, the private key may include a first invertible matrix, and a public key may be set as a compressed form of the symmetric tensor and then enabled to be publicly available. In this way, when the other electronic device wants to counterfeit signature information about the to-be-transmitted file from the first electronic device, it needs to crack the public key to obtain the private key, so the other electronic device needs to solve a symmetric tensor isomorphism problem. Due to the difficulty in solving the symmetric tensor isomorphism problem, it is very difficult for the other electronic device to crack the public key to obtain the private key for the first electronic device. At this time, it is very difficult for the other electronic device to counterfeit the signature of the first electronic device, thereby to ensure the security of the digital signature.

In actual use, based on the symmetric tensor isomorphism problem, an identity authentication protocol is created through a zero knowledge interactive protocol of a classical graph isomorphism problem. Based on the desired security, the protocol may be created several rounds, and a plurality of symmetric tensors is generated in each round. Based on the identity authentication protocol, Fiat-Shamir transformation, as a classical identity recognition protocol, is used to create a digital signature scheme.

In the digital signature scheme, important parameters may include a signature length, a public key length, and a running time for generating the private key, generating the signature and authenticating the signature. The parameters may be selected appropriately in accordance with principal parameters in the protocol (e.g., the quantity n of dimensions of the symmetric tensor, i.e., a scale of the symmetric tensor, a domain size p, i.e., a scale of a number field, the quantity r of rounds, i.e., the signature length, a security parameter λ, a depth s in the Hash tree, and the quantity t of leaf nodes in the Hash tree (t=2^{s}), i.e., the quantity of symmetric tensors for generating the public key) as well as the understanding on a best algorithm running time for the symmetric tensor isomorphism problem, so as to obtain the desired security of the digital signature, e.g., a 128-bit or 256-bit security level. In addition, prototype implementation may be performed on the protocol, so as to test an actual running time for generating the private key, generating the signature and authenticating the signature.

The to-be-transmitted file may be obtained in various ways. For example, the first electronic device may obtain the to-be-transmitted file from pre-stored files, or generated on its own initiative.

The private key may be generated by the first electronic device in advance and stored in a database, or preset by a developer and stored in the database, which will not be particularly defined herein.

When the private key is generated by the first electronic device in advance and stored in the database, the first electronic device may randomly generate at least one first invertible matrix, e.g., t−1 first invertible matrices represented by Cᵢ∈GL(n, p), i∈{1, 2, . . . , t−1}, where t is set according to the practical need, and t is greater than or equal to 2. The private key of the first electronic device may include a plurality of invertible matrices C₀, C₁, . . . , Cᵢ₋₁, where C₀ is a unit matrix having a size of n.

The first compressed data may be compressed data of the first symmetric tensor. Taking the designing of the digital signature scheme in accordance with the symmetric tensor isomorphism problem for a three-order matrix as an example, when creating the private key and the public key of the first electronic device, one first symmetric tensor represented by A₀ may be randomly generated, and A₀=(aᵢⱼₖ), i,j,k∈{1, 2, . . . , n}, aᵢⱼₖ∈GF(p). The first symmetric tensor may serve as an initial symmetric tensor for the symmetric tensor isomorphism. There is the following symmetric relationship in the data in the first symmetric tensor: aᵢⱼₖ=aᵢₖⱼ=aⱼᵢₖ=aⱼₖᵢ=a=ₖᵢⱼ=aₖⱼᵢ.

The first symmetric tensor may be compressed to obtain the first compressed data, and a data volume of the first compressed data is smaller than a data volume of the first symmetric tensor. In other words, the first symmetric tensor is compressed so as to remove a part of, or all of, redundant data in the first symmetric tensor to obtain the first compressed data, and the first symmetric tensor may be accurately restored from the first compressed data.

In a possible embodiment of the present disclosure, due to the symmetry of the first symmetric tensor, values of aᵢⱼₖ meeting i≤j≤k or meeting i>j or j>k may be removed, i.e., one half of the data may be reserved, and the other half of the data may be obtained in accordance with a symmetric relation.

For example, when the data about aᵢⱼₖ (i≤j≤k) is reserved and the values of aⱼₖᵢ need to be called, jki may be re-ranked to obtain ijk, and then the values of aⱼₖᵢ may be obtained from the first compressed data in accordance with a symmetric relation aᵢⱼₖ=aⱼₖᵢ. For example, when i=1, j=2 and k=3, and values of a₂₃₁ need to be called, a re-ranking operation may be performed, and then the values of a₂₃₁ may be obtained from the first compressed data in accordance with a symmetric relation a₁₂₃=a₂₃₁.

The entire first compressed data may be called as a compressed representation of the first symmetric tensor, which is stored in a specific data structure, e.g., a key-value data structure, where key is used to store subscripts, i.e., ijk, of the data, and value is used to store values corresponding to the subscripts. In this way, it is able to prevent same values from being stored repeatedly, thereby to remarkably save a storage space of the first electronic device.

S102: generating L pieces of second compressed data corresponding to L second symmetric tensors in accordance with the first invertible matrix and the first compressed data. The L second symmetric tensors include the first symmetric tensor and symmetric tensors isomorphic to the first symmetric tensor, where L is a positive integer greater than 1.

The first electronic device may generate the compressed data of the symmetric tensor isomorphic to the first symmetric tensor in accordance with the first compressed data and the first invertible matrix in the private key. The compressed data may be created as follows. For i∈{1, . . . , t−1}, Aᵢ=(Cᵢ,Cᵢ,Cᵢ)° A₀, and finally the L pieces of second compressed data corresponding to the L second symmetric tensors are obtained. The L second symmetric tensors may include the first symmetric tensor as well as the symmetric tensors isomorphic to the first symmetric tensor.

To be specific, the data in the first symmetric tensor other than the first compressed data may be created in accordance with the first compressed data, and the first compressed data and the other data may form the first symmetric tensor. Then, matrix multiplication may be performed on the first invertible matrix and the first symmetric tensor, so as to obtain the second compressed data corresponding to the second symmetric tensor, i.e., merely a part of the data in the second symmetric tensor, e.g., the values of aᵢⱼₖ meeting i≤j≤k, is calculated. In this way, it is able to reduce a computational burden, and improve a processing speed of the digital signature.

Alternatively, the matrix multiplication may also be performed on the first invertible matrix and the first symmetric tensor. In the case that the other data in the first symmetric tensor needs to be called, corresponding data may be obtained from the first compressed data in accordance with a symmetric relation between the other data and the first compressed data, so as to calculate the second compressed data corresponding to the second symmetric tensor.

In actual use, a value of L may be t. The L pieces of second compressed data are transmitted as the public key to the other electronic device. When the L pieces of second compressed data are transmitted as the public key to the other electronic device(s), the biggest problem lies in that a length of the public key is relatively large, so the efficiency may be adversely affected to a great extent in a scenario where the interaction of the public key is required. Hence, a character string obtained through transforming the L pieces of second compressed data is transmitted as the public key to the other device, and it may be a Hash value set in accordance with the tensor, which will be described hereinafter in details.

S103: performing digital signature on the to-be-transmitted file in accordance with a randomly-generated second invertible matrix and the first compressed data, so as to obtain a first character string.

For example, the digital signature may be performed on the to-be-transmitted file using a Hash function in accordance with the randomly-generated second invertible matrix and the first compressed data, so as to obtain the first character string.

To be specific, first signature data is generated in accordance with the randomly-generated second invertible matrix and the first compressed data, and then the digital signature is performed on the to-be-transmitted file in accordance with the first signature data to obtain the first character string. The first signature data may be a third symmetric tensor isomorphic to the first symmetric tensor, or third compressed data corresponding to the third symmetric tensor.

In actual use, for i∈{1, . . . , r} (r is a positive integer), the first electronic device may randomly generate at least one second invertible matrix represented by Dᵢ∈GL(n, p). In other words, the first signature data may be generated in accordance with the randomly-generated second invertible matrix and the first compressed data, and the first signature data may be at least one third symmetric tensor isomorphic to the first symmetric tensor or the third compressed data corresponding to the at least one third symmetric tensor. The first signature data may be created through a formula Bᵢ=(Dᵢ, Dᵢ, Dᵢ)° A₀, i∈{1, . . . , r}, and its creation mode is similar to that of the second compressed data, which will thus not be particularly defined herein.

Then, the digital signature may be performed on the to-be-transmitted file (represented by M) through the Hash function (represented by H). To be specific, the to-be-transmitted file M is concatenated to the first signature data, and a Hash operation is performed on a resultant character string obtained after concatenation, so as to obtain the first character string.

In the case that the first signature data is the third symmetric tensor, the to-be-transmitted file M is concatenated to the third symmetric tensors B₁, . . . , and Bᵣ, and the Hash operation is performed on a resultant character string obtained after the concatenation so as to obtain the first character string represented by H(M|B₁| . . . |Bᵣ), where M|B₁| . . . |Bᵣ represents the concatenation of the to-be-transmitted file M to the third symmetric tensors B₁, . . . , and Bᵣ. When the Hash operation is performed on the character string obtained after concatenating the to-be-transmitted file M to the third symmetric tensors B₁, . . . , and Bᵣ, it is able to increase the data volume, thereby to improve the security of the first character string generated through the Hash function.

In the case that the first signature data is the third compressed data, the to-be-transmitted file M is concatenated to the third compressed data, and then the Hash operation is performed on a resultant character string obtained after the concatenation, so as to obtain the first character string. When the Hash operation is performed on the resultant character string after concatenating the to-be-transmitted file M to the third compressed data, it is able to accelerate the computation.

The first character string may be a binary character string consisting of 0s and 1s and having a length of r*s. The parameter s is a parameter in the identity authentication protocol, and the parameters s and t meet t=2^{s}. An input of the Hash function H may be a character string with any length, and a character string outputted thereby has a length of r*s consisting of 0s and 1s.

S104: creating a Hash value of a root node in a Hash tree in accordance with L pieces of created data. The L pieces of created data are the L pieces of second compressed data or the L second symmetric tensors.

In this step, in cryptography and computer science, the Hash tree is a tree-like data structure including a plurality of layers, each layer consists of at least one node, and each node uses a Hash of a data block as a label. Except the leaf nodes, the other node(s) use(s) an encrypted Hash of its child node label(s) as a label.

The Hash value of the root node in the Hash tree may be created through the Hash function in accordance with the L pieces of created data. In addition, the Hash tree may be created directly in accordance with the L pieces of created data, or in accordance with the L pieces of created data and the randomly-generated first target character string.

One piece of created data may be one second symmetric tensor or one piece of compressed data, which will not be particularly defined herein. It should be appreciated that, when creating the Hash tree, types of the created data need to be unified, i.e., the Hash values of all the leaf nodes in the Hash tree may be directly created in accordance with the second symmetric tensor, or in accordance with the second compressed data.

When the Hash tree is created in accordance with the L pieces of created data and the randomly-generated first target character string, to be specific, the first target character string represented by MerkleKey may be randomly generated through a random function, e.g., uniform or random.

MerkleKey is a character string consisting of 0s and 1s and having a length of λ, and λ is a security parameter, i.e., λ is set in accordance with a desired security level of the digital signature. For example, when a security level of 128 bit needs to be achieved for the digital signature, λ may be set as 128.

The leaf node in the Hash tree may be created in accordance with the L pieces of created data. To be specific, an s^{th} layer in the Hash tree, i.e., a layer corresponding to the leaf node, is created through the Hash function H. When the created data is the second symmetric tensor, a Hash value of the leaf node in the s^{th} layer may be calculated through h_{s,i}=H(Aᵢ|(2^{s}+i)|MerkleKey), where 0≤i≤t−1, h_{s,i} represents the Hash value of an i^{th} leaf node in the layer corresponding to the leaf node, i.e., the s^{th} layer, and a symbol | represents concatenation of the character strings. In this way, it is able to increase the data volume, thereby to improve the security of the first character string generated through the Hash function.

When the created data is the second compressed data, Aᵢ in h_{s,i}=H(Aᵢ|(2^{s}+i)|MerkleKey) may be replaced by the second compressed data, so as to further accelerate the computing speed.

The Hash function H is continuously used to create the other internal nodes in the Hash tree using a formula h_{k,i}=H(h_{k+1,2i}|h_{k+1,2i+1}|(2^{k}+i)|MerkleKey), where 0≤k<s, 0≤i<2^{k}, h_{k,i} represents a Hash value of an i^{th} node in a k^{th} layer, and h_{k+1,2}i and h_{k+1,2i+1} are Hash values of two child nodes of the i^{th} node, i.e., a parent node. In this way, all elements in the Hash tree, including the root node in the Hash tree represented by h_{0,0}, may be created, and a Hash value of h_{0,0} may serve as a part of the public key.

S105: generating signature information about the to-be-transmitted file for the first electronic device in accordance with the first character string, the first invertible matrix, the second invertible matrix, the L pieces of second compressed data and the Hash value of the root node in the Hash tree.

The signature information includes the first character string, a target matrix (the target matrix may be generated in accordance with the first character string, the first invertible matrix and the second invertible matrix), the N pieces of second compressed data selected from the L pieces of second compressed data in accordance with the first character string, and an authentication path corresponding to each piece of second compressed data in the N pieces of second compressed data. And the authentication path is an authentication path for the created data relative to the root node in the Hash tree. The authentication path of the created data relative to the root node in the Hash tree includes a series of Hash values, i.e., all information desired for the calculation starting from the created data to the Hash value of the root node in the Hash tree.

In a possible embodiment of the present disclosure, the signature information may for example include (i) a plurality of character strings into which the first character string is spliced; (ii) a target matrix generated in accordance with the character strings, the first invertible matrix and the second invertible matrix; (iii) the N pieces of second compressed data; and (iv) the authentication path corresponding to each piece of second compressed data.

In the embodiments of the present disclosure, the digital signature is performed through the symmetric tensor isomorphism problem in conjunction with the Hash tree. When the other electronic device(s) need(s) to counterfeit the signature information about the to-be-transmitted file generated by the first electronic device, it needs to crack the public key (which includes the compressed data corresponding to the isomorphic symmetric tensors or the Hash value generated in accordance with the compressed data corresponding to the isomorphic symmetric tensors) to obtain the private key, i.e., the other electronic device(s) need(s) to solve a decryption problem in the Hash tree and the symmetric tensor isomorphism problem. In the case that the other electronic device does not know the private key, it is very difficult to counterfeit the private key in accordance with the public key, i.e., very difficult to counterfeit the digital signature, so it is able to improve the security of the digital signature.

In addition, when solving the tensor isomorphism problem and the symmetric tensor isomorphism problem through such an algorithm as Gröbner basis, data symmetry and relationality of the symmetric tensor are greater than those of the other tensor, and meanwhile the accuracy of an attach algorithm is low, so as compared with the tensor isomorphism problem, a convergence speed of solving the symmetric tensor isomorphism problem, i.e., determining whether the two symmetric tensors are isomorphic tensors and solving the invertible matrix mutually transformed between the two tensors in the case that the two symmetric tensors are isomorphic tensors, is smaller. Hence, the security of the digital signature designed when the symmetric tensor isomorphism problem is used as the algorithm problem is higher than that designed when the tensor isomorphism problem is used.

Table 1 shows cracking time desired for attacking different digital signature scheme through Gröbner basis, and the algorithms for the digital signature schemes are used to solve the symmetric tensor isomorphism problem and the tensor isomorphism problem, where N/A represents that it is impossible to crack the digital signature. As shown in Table 1, in the case of different parameters in the protocol, it is more difficult to solve the symmetric tensor isomorphism problem than the tensor isomorphism problem.

TABLE 1
cracking time for attacking different digital signature
schemes through Gröbner basis

| Parameters in protocol | (n = 4, p = 5) | (n = 5, p = 5) |
|---|---|---|
| Tensor isomorphism problem | 0.076 s | 94.448 s |
| Symmetric tensor | N/A | N/A |
| isomorphism problem | | |

In a possible embodiment of the present disclosure, S105 specifically includes: splicing the first character string into P character strings, P being a positive integer greater than 1; performing matrix multiplication on an inverse matrix of the first invertible matrix and the second invertible matrix in accordance with the P character strings, so as to generate a target matrix; selecting N pieces of second compressed data from the L pieces of second compressed data in accordance with the P character strings, N being a positive integer; and determining an authentication path corresponding to each piece of second compressed data in the N pieces of second compressed data in accordance with the Hash value of the root node in the Hash tree and the second compressed data, the authentication path being an authentication path of the created data relative to the root node in the Hash tree. The signature information includes the P character strings, the target matrix, the N pieces of second compressed data, and authentication paths corresponding to the N pieces of second compressed data.

In the embodiments of the present disclosure, the first character string may be spliced into a plurality of character strings, e.g., r character strings each consisting of 0s and 1s and having a length of s, and the r character strings are represented by ƒ₁, . . . , ƒᵣ. At this time, r is greater than 1, a decimal value of each of the r character strings is within a range of 0 to t−1, and a value of P is equal to r.

The target matrix may be generated in accordance with the P character strings, the first invertible matrix and the second invertible matrix. To be specific, for i∈{1, . . . , r}, the first invertible matrix with a subscript ƒᵢ is obtained from the first invertible matrices, and then the target matrix is calculated by the first electronic device through Eᵢ=DᵢC_{ƒ}_{ᵢ}⁻¹, where Eᵢ represents the target matrix and the quantity of the target matrices may be plural, and C_{ƒ}_{ᵢ}⁻¹ represents an inverse matrix of an (ƒᵢ)^{th} first invertible matrix in the private key. For example, when a character string ƒᵢ is 1, C_{ƒ}_{ᵢ}⁻¹ is an inverse matrix of a first invertible matrix C₁ in the private key. In other words, the target matrix may be obtained through performing the matrix multiplication on a second invertible matrix Dᵢ and the inverse matrix of the first invertible matrix C_{ƒ}_{ᵢ} in the private key.

Then, the N pieces of second compressed data may be selected from the L pieces of second compressed data in accordance with the P character strings. To be specific, the N pieces of second compressed data A_{ƒ}_{₁}, . . . , A_{ƒ}_{ᵣ} may be selected from the second compressed data corresponding to the second symmetric tensors A₀, A₁, . . . , Aₜ₋₁, where N is equal to r.

For i∈{1, . . . , r}, the authentication path pathᵢ corresponding to the second compressed data may be calculated in accordance with the second compressed data corresponding to the second symmetric tensor A_{ƒ}_{ᵢ} and the Hash value of the root node in the Hash tree. And this authentication path may be an authentication path of the created data (the second compressed data or the second symmetric tensor) relative to the root node in the Hash tree. The authentication path includes a series of Hash values, i.e., all information desired for the calculation starting from the created data to the Hash value of the root node in the Hash tree.

In other words, for path, calculated in accordance with the created data, when the created data is the second symmetric tensor, pathᵢ(A_{ƒ}_{ᵢ})=h_{0,0}. This formula represents a procedure of calculating A_{ƒ}_{ᵢ} to h_{0,0}, i.e., repeatedly calling the Hash function in accordance with A_{ƒ}_{ᵢ} and the Hash values in the authentication path until the Hash value of the root node in the Hash tree has been obtained. In other words, its essence lies in traversing the Hash tree in accordance with the authentication path pathᵢ, so as to obtain the leaf node h_{s,ƒ}_{ᵢ} in the Hash tree in accordance with the second symmetric tensor A_{ƒ}_{ᵢ} and traverse from the leaf node _{s,ƒ}_{ᵢ} to the root node h_{0,0} in the Hash tree, thereby to obtain the Hash value of the root node in the Hash tree. When the created data is the second compressed data, A_{ƒ}_{ᵢ} in pathᵢ(A_{ƒ}_{ᵢ})=h_{0,0} may be replaced by the second compressed data.

Finally, the signature information (ƒ₁, . . . , ƒᵣ, E₁, . . . . , Eᵣ, V_{ƒ}_{₁}, . . . , V_{ƒ}_{ᵣ}, path ₁, . . . , pathᵣ) about the to-be-transmitted file generated by the first electronic device may be determined in accordance with the r character strings, the plurality of target matrices, the N pieces of second compressed data and the authentication path corresponding to each piece of second compressed data, where V_{ƒ}_{₁}, . . . , V_{f}_{ᵣ} represent the second compressed data corresponding to the second symmetric tensors A_{ƒ}_{₁}, . . . , A_{ƒ}_{ᵣ}, i.e., compressed representations of the second symmetric tensors.

When the other electronic device, e.g., a third electronic device, wants to pretend to be the first electronic device and generate the digital signature for the to-be-transmitted file M, because the third electronic device has no private key, it is impossible for the third electronic device to generate the target matrices in accordance with the private key, i.e., to generate the target matrices E₁, . . . , Eᵣ through Eᵢ=DᵢC_{ƒ}_{ᵢ}⁻¹. In addition, a symmetric tensor isomorphism problem needs to be solved to crack the private key, so it is very difficult for the third electronic device to obtain the private key of the first electronic device. Meanwhile, the public key obtained by the third electronic device is generated in accordance with the isomorphic symmetric tensors in conjunction with the Hash tree, and it includes the Hash value of the root node in the Hash tree. In this regard, when the third electronic device wants to counterfeit the signature, it needs to crack the Hash tree. However, due to the difficulty in the design of a primary image of the Hash function, it is very difficult for the third electronic device to counterfeit the signature information.

In addition, any direct attacking method performed by the third electronic device on the protocol needs to generate a plurality of character strings consisting of 0s and 1s, i.e., g₁, . . . , gᵣ∈{0,1, . . . , t−1}, so that, after calculating Bᵢ=(Dᵢ,Dᵢ,Dᵢ)° A_{g}_{ᵢ}, i∈{1, . . . , r}, ƒ₁, . . . , ƒᵣ obtained through calculating H(M|B₁| . . . |Bᵣ) meets ƒᵢ=gᵢ, i∈{1, . . . , r}. However, depending on the property of the Hash function, an attack success rate does not obviously exceed ½^{rs}.

Hence, based on the above two, it is very difficult for the third electronic device to counterfeit the signature information generated by the first electronic device.

Further, parameter combinations in the protocol may be set as shown in Table 2, so as to achieve the 128-bit security level.

TABLE 2
some parameter combinations to achieve the 128-bit security level

| | | | | | Length of | Length of |
|---|---|---|---|---|---|---|
| | n | p | r | s | public key | signature |
| Combination 1 | 9 | 8191 | 128 | 1 | 32 | 55280 |
| Combination 2 | 9 | 8191 | 16 | 8 | 32 | 10508 |
| Combination 3 | 9 | 8191 | 10 | 12 | 32 | 7852 |

In Table 2, a unit of each of the length of the public and the length of the signature is byte.

In the embodiments of the present disclosure, the first character string is spliced into the P character strings. Next, the matrix multiplication is performed on the inverse matrix of the first invertible matrix and the second invertible matrix in accordance with the P character strings, so as to generate the target matrix. Next, the N pieces of second compressed data is selected the L pieces of second compressed data in accordance with the P character strings. Then, the authentication path corresponding to each piece of second compressed data in the N pieces of second compressed data is determined in accordance with the Hash value of the root node in the Hash tree and the send compressed data, and the authentication path is an authentication path of the created data relative to the root node in the Hash tree. The signature information includes the P character strings, the target matrix, the N pieces of second compressed data, and the authentication paths corresponding to the N pieces of second compressed data. In the case that the other electronic device does not know the private key and merely know the public key generated in accordance with the symmetric tensor isomorphism problem in conjunction with the Hash tree, it is very difficult for the other electronic device to counterfeit the invertible matrix in accordance with the public key, i.e., to counterfeit the private key. In addition, it is also very difficult to crack the Hash tree in accordance with the root node in the Hash tree. As a result, it is very difficult to counterfeit the digital signature, so it is able to improve the security of the digital signature.

In a possible embodiment of the present disclosure, the N pieces of second compressed data include target compressed data, and the target compressed data is any compressed data in the N pieces of second compressed data, wherein the determining the authentication path corresponding to each piece of second compressed data in the N pieces of second compressed data in accordance with the Hash value of the root node in the Hash tree and the second compressed data includes: determining a target Hash value of each node between a leaf node in the Hash tree corresponding to target data and the root node in accordance with a Hash value of the leaf node in the Hash tree corresponding to the target data and the Hash value of the root node. The target data is the created data corresponding to the target compressed data, and an authentication path of the target data relative to the root node in the Hash tree includes the target Hash value and a position of each node between the leaf node in the Hash tree corresponding to the target data and the root node.

The authentication path of the target data relative to the root node in the Hash tree has been specifically described hereinabove, and the target data may be the created data corresponding to the target compressed data. When creating the Hash tree, a value of the Hash function, i.e., the Hash value, may be stored for each node in the Hash tree (e.g., the Hash value for a node A includes, and merely includes, Hash values of its two child nodes), a position and a function of the first target character string MerkleKey. Hence, when the Hash values of the two child nodes, the position of the node A and MerkleKey are known, the Hash value for the node A may be calculated through the Hash function H. The authentication path is just all information desired for calculating the Hash values of these nodes between the leaf node corresponding to the target data and the root node, so as to finally calculate the Hash value of the root node. It should be appreciated that, a signature process of the first electronic device and the Hash function adopted for the authentication process of the second electronic device should be uniform.

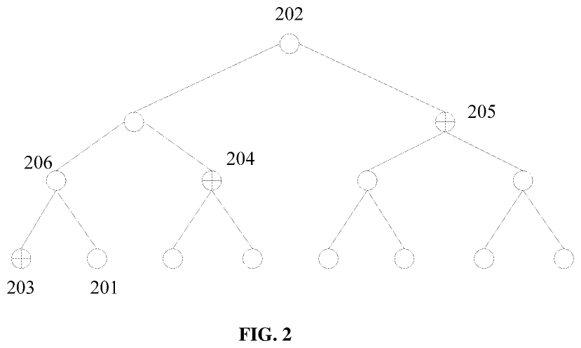

As shown in FIG. 2, which shows the computer-implemented authentication path of the created data corresponding to the target compressed data relative to the root node in the Hash tree, at first, the Hash function is called in accordance with the created data corresponding to the target compressed data (the created data is the target compressed data or the second symmetric tensor corresponding to the target compressed data), so as to determine a Hash value of a leaf node 201 in the Hash tree corresponding to the target data. Leaf nodes 203, 204 and 205 are included when traversing from the leaf node 201 to a root node 202.

The nodes between the leaf node 201 and the root node 202 differ from the other nodes, e.g., a node 206, in that the node 206 is calculated in accordance with the Hash values of the leaf nodes 201 and 203, while a Hash value of the node between the leaf node 201 and the root node 202 needs to be obtained in accordance with its position. The Hash value of the root node in the Hash tree may be calculated in accordance with the Hash values of these nodes between the leaf node 201 and the root node 202 in conjunction with the target data.

In the case that the Hash value of the leaf node 201 has been obtained, a position of the leaf node 203 and its Hash value may be obtained. For example, when the leaf node 203 is located on the left of the leaf node 201, a Hash value of the leaf node 203 on the left of the leaf node 201 is obtained, and the authentication path of the target data relative to the root node in the Hash tree includes the position and the Hash value of the leaf node 203.

Then, the Hash function may be called in accordance with the Hash values of the leaf nodes 201 and 203, so as to obtain the Hash value of its parent node. Correspondingly, the nodes between the leaf node 201 and the root node 202 include the node 204 on the right of the parent node, i.e., the Hash value of the node 204 in the Hash tree may be obtained, and the authentication path of the target data relative to the root node in the Hash tree includes a position and the Hash value of the node 204.

A Hash value of the node 205 may be obtained in a similar way as the Hash value of the node 204, which will not be particularly defined herein. Finally, a Hash value may be calculated in accordance with the Hash value of the parent node of the node 204 and the Hash value of the node 205, so that this Hash value is equal to the Hash value of the root node in the Hash tree. The authentication path of the target data relative to the root node in the Hash tree includes the positions and the Hash values of the nodes 203, 204 and 205.

In the embodiments of the present disclosure, the target Hash value of each node between the leaf node in the Hash tree corresponding to the target data and the root node may be determined in accordance with the Hash value of the leaf node in the Hash tree corresponding to the target data and the Hash value of the root node in the Hash tree, so as to obtain the authentication path of the target data relative to the root node in the Hash tree, thereby to achieve the digital signature of the first electronic device in accordance with the authentication path.

In a possible embodiment of the present disclosure, step S103 specifically includes: generating first signature data in accordance with the first compressed data and the randomly-generated second invertible matrix, the first signature data being a third symmetric tensor isomorphic to the first symmetric tensor or third compressed data corresponding to the third symmetric tensor; and performing the digital signature on the to-be-transmitted file in accordance with the first signature data, so as to obtain the first character string.

In the embodiments of the present disclosure, for i∈{1, . . . , r}, r is a positive integer, and the first electronic device may randomly generate at least one second invertible matrix represented by Dᵢ∈GL(n, p). In other words, the first signature data may be created in accordance with the randomly-generated second invertible matrix and the first compressed data, and this first signature data may be at least one third symmetric tensor isomorphic to the first symmetric tensor or the third compressed data corresponding to the at least one third symmetric tensor. The first signature data may be created through a formula Bᵢ=(Dᵢ,Dᵢ,Dᵢ)° A₀, i∈{1, . . . , r}, which is similar to a creation mode of the second compressed data and thus will not be particularly defined herein.

Then, the digital signature may be performed on the to-be-transmitted file M through the Hash function H. To be specific, the to-be-transmitted file M is concatenated to the first signature data, and a Hash operation is performed on a resultant character string obtained after concatenation, so as to obtain the first character string.

In the case that the first signature data is the third symmetric tensor, the to-be-transmitted file M is concatenated to the third symmetric tensors B₁, . . . , and Bᵣ, and the Hash operation is performed on a resultant character string obtained after the concatenation so as to obtain the first character string represented by H(M|B₁| . . . |Bᵣ) , where M|B₁| . . . |Bᵣ represents the concatenation of the to-be-transmitted file M to the third symmetric tensors B₁, . . . , and Bᵣ. When the Hash operation is performed on the character string obtained after concatenating the to-be-transmitted file M to the third symmetric tensors B₁, . . . , and Bᵣ, it is able to increase the data volume, thereby to improve the security of the first character string generated through the Hash function.

In the case that the first signature data is the third compressed data, the to-be-transmitted file M is concatenated to the third compressed data, and then the Hash operation is performed on a resultant character string obtained after the concatenation, so as to obtain the first character string. When the Hash operation is performed on the resultant character string after concatenating the to-be-transmitted file M to the third compressed data, it is able to accelerate the computation.

The first character string may be a binary character string consisting of 0s and 1s and having a length of r*s. The parameter s is a parameter in the identity authentication protocol, and the parameters s and t meet t=2^{s}. An input of the Hash function H may be a character string with any length, and a character string outputted thereby has a length of r*s consisting of 0s and 1s.

In the embodiments of the present disclosure, the first signature data is generated in accordance with the first compressed data and the randomly-generated second invertible matrix, and the first signature data is the third symmetric tensor isomorphic to the first symmetric tensor or the third compressed data corresponding to the third symmetric tensor. Then, the digital signature is performed on the to-be-transmitted file in accordance with the first signature data, so as to obtain the first character string. In this way, it is able to achieve the digital signature.

In a possible embodiment of the present disclosure, step S104 specifically includes: creating a Hash value of a leaf node in the Hash tree in accordance with the L pieces of created data and a randomly-generated first target character string; and creating Hash values of nodes in the Hash tree other than the leaf node in accordance with the Hash value of the leaf node in the Hash tree and the first target character string. Specifically, the nodes in the Hash tree other than the leaf node include the root node in the Hash tree.

A specific procedure of creating the Hash tree in accordance with the L pieces of created data and the randomly-generated first target character string has been described herein.

The first target character string MerkleKey may be randomly generated through a random function, e.g., uniform or random.

MerkleKey is a character string consisting of 0s and 1s and having a length of λ, and λ is a security parameter, i.e., λ is set in accordance with a desired security level of the digital signature. For example, when a security level of 128 bit needs to be achieved for the digital signature, λ may be set as 128.

The leaf node in the Hash tree may be created in accordance with the L pieces of created data. To be specific, an s^{th} layer in the Hash tree, i.e., a layer corresponding to the leaf node, is created through the Hash function H. When the created data is the second symmetric tensor, a Hash value of the leaf node in the s^{th} layer may be calculated through h_{s,i}=H(Aᵢ|(2^{s}+i)|MerkleKey), where 0≤i≤t−1, h_{s,i} represents the Hash value of an i^{th} leaf node in the layer corresponding to the leaf node, i.e., the s^{th} layer, and a symbol | represents concatenation of the character strings.

When the created data is the second compressed data, Aᵢ in h_{s,i}=H(Aᵢ|(2^{s}+i)|MerkleKey) may be replaced by the second compressed data.

The Hash function H is continuously used to create the other internal nodes in the Hash tree using a formula h_{k,i}=H(h_{k+1,2i}|h_{k+1,2i+1}|(2^{k}+i)|MerkleKey), where 0≤k<s, 0≤i<2^{k}, h_{k,i} represents a Hash value of an i^{th} node in a k^{th} layer, and h_{k+1,2}i and h_{k+1,2i+1} are Hash values of two child nodes of the i^{th} node, i.e., a parent node. In this way, all elements in the Hash tree, including the root node in the Hash tree represented by h_{0,0} , may be created, and a Hash value of h_{0,0} may serve as a part of the public key.

In the embodiments of the present disclosure, the Hash value of the root node in the Hash tree may be created in accordance with the L pieces of created data and the randomly-generated first target character string, so as to increase the difficulty in cracking the Hash tree, thereby to further improve the security of the digital signature.

In a possible embodiment of the present disclosure, prior to S101, the signature method further includes: generating a public key corresponding to the private key, the public key including the first target character string and the Hash value of the root node in the Hash tree; and enabling the public key to be publicly available.

In the embodiments of the present disclosure, a procedure of generating the public key in accordance with the private key has been described. In order to enable the other electronic device, upon the receipt of the signature information and the to-be-transmitted file from the first electronic device, to authenticate a transmitter of the to-be-transmitted file, i.e., the first electronic device, the public key corresponding to the private key needs to be enabled to be publicly available.

The private key includes the first invertible matrix Cᵢ∈GL(n, p),i∈{1,2, . . . , t−1} as well as a unit matrix C₀ having a size of n. The compressed data corresponding to the symmetric tensor isomorphic to the first symmetric tensor may be generated in accordance with the first invertible matrix and the first compressed data, so as to obtain the L pieces of second compressed data, where L is equal to t, and it may be represented by Vᵢ, i∈{0, . . . , t−1}.

The first target character string MerkleKey is randomly generated, and then the Hash value of the leaf node in the Hash tree is created through the Hash function in accordance with MerkleKey and the L pieces of created data. A specific creation procedure has already been described in detail hereinabove, and thus will not be particularly defined herein. It should be appreciated that, a signature process of the first electronic device and the Hash function adopted for the authentication process of the second electronic device should be uniform, and the first target character strings adopted thereby should be uniform.

The Hash value of the other node in the Hash tree may be continuously created through the Hash function in accordance with the Hash value of the leaf node and MerkleKey, so as to finally create the Hash value of the root node in the Hash tree. The public key corresponding to the private key includes the first target character string and the Hash value of the root node in the Hash tree.

Then, the generated public key may be enabled to be publicly available, and correspondingly, the other electronic device may obtain the public key from the first electronic device.

In the embodiments of the present disclosure, the L pieces of second compressed data corresponding to the symmetric tensor isomorphic to the initial symmetric tensor may be created in accordance with the private key and the first compressed data corresponding to the randomly-created initial symmetric tensor, the Hash value of the root node in the Hash tree may be created in accordance with the L pieces of second compressed data and the first target character string, and then the Hash value of the root node in the Hash tree and the first target character string may be enabled to be publicly available as the public key of the first electronic device. In this way, it is able to remarkably reduce a length of the public key, thereby to improve the efficiency in a scenario where the interaction of the public key is required.

Second Embodiment

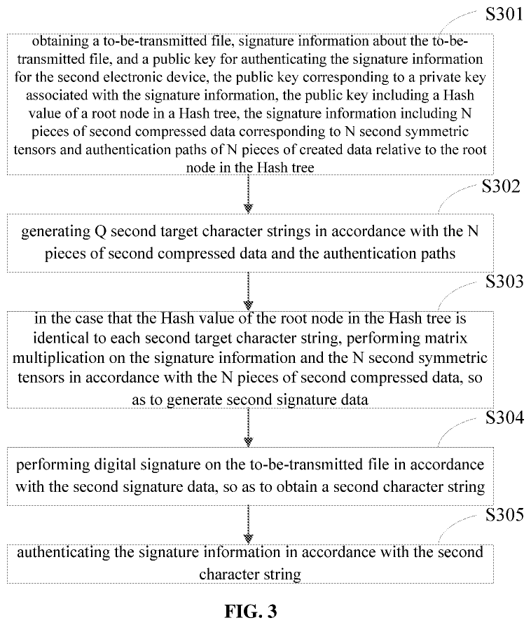

As shown in FIG. 3, the present disclosure provides in this embodiment a signature information authentication method realized by a second electronic device, which includes: S301 of obtaining a to-be-transmitted file, signature information about the to-be-transmitted file, and a public key for authenticating the signature information for the second electronic device, the public key corresponding to a private key associated with the signature information, the public key including a Hash value of a root node in a Hash tree, the signature information including N pieces of second compressed data corresponding to N second symmetric tensors and authentication paths of N pieces of created data relative to the root node in the Hash tree, each piece of created data being one piece of second compressed data or a second symmetric tensor corresponding to one piece of second compressed data; S302 of generating Q second target character strings in accordance with the N pieces of second compressed data and the authentication paths, Q being a positive integer; S303 of, in the case that the Hash value of the root node in the Hash tree is identical to each second target character string, performing matrix multiplication on the signature information and the N second symmetric tensors in accordance with the N pieces of second compressed data, so as to generate second signature data, the second signature data being a fourth symmetric tensor isomorphic to the N second symmetric tensors or fourth compressed data corresponding to the fourth symmetric tensor; S304 of performing digital signature on the to-be-transmitted file in accordance with the second signature data, so as to obtain a second character string; and S305 of authenticating the signature information in accordance with the second character string.

In the embodiments of the present disclosure, the second electronic device is an electronic device for receiving the to-be-transmitted file, and the first electronic device may transmit the to-be-transmitted file and the signature information about the to-be-transmitted file to the second electronic device. Correspondingly, the second electronic device may receive the to-be-transmitted file and the signature information about the to-be-transmitted file.

In addition, prior to transmitting the to-be-transmitted file and the signature information about the to-be-transmitted file, the first electronic device may enable the public key for authenticating its identity to be publicly available, and correspondingly, the second electronic device may obtain the public key.

The public key corresponds to the private key associated with the signature information, i.e., the public key and the private key for generating the signature information form a key pair, and the public key includes the Hash value of the root node in the Hash tree and the first target character string.

The signature information includes the N pieces of compressed data corresponding to the N second symmetric tensors and the authentication paths of the N pieces of created data relative to the root node in the Hash tree, and one piece of created data is one piece of second compressed data or the second symmetric tensor corresponding to one piece of second compressed data. In an authentication process of the signature information and a digital signature process, types of the created data for creating the Hash value of the node in the Hash tree should be uniform.

In other words, when the second compressed data is used to create the Hash value of the node in the Hash tree in the digital signature process, the second compressed data should also be directly used in the authentication process to generate the Q second target character strings. When the second symmetric tensor is used to create the Hash value of the node in the Hash tree in the digital signature process, the second compressed data needs to be restored into the second symmetric tensor in the authentication process and then the second symmetric tensor is used to generate the Q second target character strings.

To be specific, when the created data is the second symmetric tensor, for i∈{1, . . . , r}, the second compressed data may be restored into the second symmetric tensor. A formula pathᵢ(A_{ƒ}_{ᵢ})=h_{0,0} is adopted in accordance with the second symmetric tensor A_{ƒ}_{ᵢ} and its authentication path pathᵢ, i.e., the Hash function is called repeatedly, until a second target character string has been obtained. In the case that the signature information is not counterfeited, the Hash value of the root node in the Hash tree may be obtained in accordance with the second symmetric tensor A_{ƒ}_{ᵢ} and its authentication path pathᵢ. Hence, whether the second target character string is the same as the Hash value of the root node in the Hash tree may be determined, so as to perform primary authentication on the signature information.

When the created data is the second compressed data, a similar calculation mode is adopted, merely with a difference in that A_{ƒ}_{ᵢ} in pathᵢ(A_{ƒ}_{ᵢ})=h_{0,0} is directly replaced by the second compressed data, where pathᵢ is the authentication path of the second compressed data relative to the root node in the Hash tree.

In this regard, the Hash function is repeatedly called in accordance with the second compressed data and the authentication information of the created data relative to the root node in the Hash tree in the signature information to obtain the second target character string, and then the second target character string is compared with the Hash value of the root node in the Hash tree, so as to perform the primary authentication on the signature information.

When each second target character string is the same as the Hash value of the root node in the Hash tree in the public key, the primary authentication has been performed successfully, and then secondary authentication is performed. Otherwise, in the case that at least one second target character string is different from the Hash value of the root node in the Hash tree, the primary authentication has been performed unsuccessfully.

In the secondary authentication, the matrix multiplication may be performed on the signature information and the N second symmetric tensors in accordance with the N pieces of second compressed data, so as to generate the second signature data. To be specific, the second signature data is generated through a formula Bᵢ=(Eᵢ,Eᵢ,Eᵢ)° A_{ƒ}_{ᵢ}, and the second signature data may be at least one fourth symmetric tensor or fourth compressed data corresponding to the at least one fourth symmetric tensor, where B′ᵢ represents the fourth symmetric tensor, and Eᵢ represents a target matrix.

To be specific, the matrix multiplication may be performed on the target matrix in the signature information and the N second symmetric tensors in accordance with the N pieces of second compressed data, so as to generate the second signature data. The second signature data is generated in a similar way to the first signature data, which will thus not be particularly defined herein.

Then, the digital signature may be performed on the to-be-transmitted file through the Hash function in accordance with the second signature data, so as to obtain the second character string. The second character string is generated in a similar way to the first character string, which will not be particularly defined herein. In addition, the Hash function for the digital signature in the digital signature process is the same as that for the digital signature in the authentication process.

The second character string may also be a binary character string consisting of 0s and 1s and having a length of r*s.

Finally, the signature information may be authentication in accordance with the second character string. In the case that the second character string is completely the same as the character string in the signature information, the signature information has been authenticated successfully, i.e., the to-be-transmitted file is indeed transmitted by the first electronic device. In the case that the second character string is not completely the same as the character string in the signature information, the signature information has been authenticated unsuccessfully, i.e., the to-be-transmitted file is transmitted by the other electronic device rather than the first electronic device. In this way, through the primary authentication and secondary authentication on the signature information, it is able for the second electronic device to ensure the accuracy of the authentication.

In the embodiments of the present disclosure, upon the receipt of the public key from the first electronic device, the second electronic device may conveniently authenticate the signature information in accordance with the public key, the received to-be-transmitted file and the signature information about the to-be-transmitted file, so as to authenticate an identity of a transmitter of the to-be-transmitted file. In addition, through the primary authentication and secondary authentication on the signature information, it is able to ensure the accuracy of the authentication.

In a possible embodiment of the present disclosure, the first signature data is a third symmetric tensor isomorphic to a first symmetric tensor or third compressed data corresponding to the third symmetric tensor, and the first signature data is used to perform the digital signature on the to-be-transmitted file.

In the embodiments of the present disclosure, in the case that the type of the second target data corresponds to the type of the first target data, it means that, when the first signature data is a symmetric tensor, the second signature data should also be a symmetric tensor, and when the first signature data is a compressed representation of a symmetric tensor, the second signature data should also be a compressed representation of a symmetric tensor. In this way, it is able to ensure the consistency in the Hash function for the digital signature and the authentication.

In a possible embodiment of the present disclosure, the signature information includes P character strings, where P is a positive integer greater than 1, wherein the authenticating the signature information in accordance with the second character string includes: splicing the second character string into K character strings, P being equal to K; and in the case that the P character strings are identical to the K character strings respectively, determining that the signature information has been authenticated successfully, or in the case that a third target character string in the P character strings is different from a fourth target character string in the K character strings, determining that the signature information has been authenticated unsuccessfully. A position of the third target character string in the P character strings corresponds to a position of the fourth target character string in the K character strings, and the third target character string is any character string in the P character strings.

In the embodiments of the present disclosure, the second character string may be spliced into a plurality of character strings, e.g., r character strings ƒ₁, . . . , ƒᵣ consisting of 0s and 1s and having a length of s.

For i∈{1, . . . , r}, when ƒᵢ=ƒᵢ, the signature information has been authentication successfully; otherwise, the signature information has been authentication unsuccessfully.

In the embodiments of the present disclosure, the second character string is spliced into a plurality of character strings, and the plurality of character strings is compared with the plurality of character strings in the signature information respectively. In the case that the plurality of character strings is the same as the plurality of character strings in the signature information respectively, the signature information has been authenticated successfully. In the case that there is at least one different character string, the signature information has been authenticated unsuccessfully. In this way, it is able to very conveniently authenticate the signature information.

In order to show advantages of the above-mentioned digital signature method and the above-mentioned signature information authentication method, the scheme in the embodiments of the present disclosure is compared with the other schemes in terms of running time, public key length and signature length. The scheme in the embodiments of the present disclosure is a symmetric tensor isomorphism-based scheme (with the addition of a Hash tree technology) with a 2.4 GHz processor, and the other schemes include a lattice-based signature scheme Falcon with a 3.3 GHz processor, a symmetric tensor isomorphism-based signature scheme with a 2.4 GHz processor and a Hash function-based signature scheme SPHINCS+ with a 3.5 GHz processor.

The scheme in the embodiments of the present disclosure is implemented through a prototype design pattern of Python. Table 3 shows running time for each scheme, and Table 4 shows the public key length and the signature length.

TABLE 3
Running time for each scheme

| | Running time | | |
|---|---|---|---|
| | Time for | | |
| | generating | | |
| | public key and | Signature | Authentication |
| | private key | time | time |
| Signature scheme | (second) | (second) | (second) |
| Symmetric tensor | 0.161 | 0.020 | 0.010 |
| isomorphism-based scheme | | | |
| (with the addition of a Hash | | | |
| tree technology) with a | | | |
| 2.4 GHz processor | | | |
| SPHINCS+ with a 3.5 GHz | 0.202 | 3.030 | 0.0032 |
| processor | | | |
| Falcon with a 3.3 GHz | 1.020 | 0.258 | 0.003 |
| processor | | | |
| Symmetric tensor | 0.150 | 0.026 | 0.023 |
| isomorphism-based | | | |
| signature scheme with a | | | |
| 2.4 GHz processor | | | |

TABLE 4
Public key length and signature length for each scheme

Information length

| | Public key | Signature |
|---|---|---|
| | length | length |
| Signature scheme | (Bytes) | (Bytes) |
| Symmetric tensor | 32 | 7852 |
| isomorphism-based scheme (with the | | |
| addition of a Hash tree technology) | | |
| with a 2.4 GHz processor | | |
| SPHINCS+ with a 3.5 GHz | 32 | 16976 |
| processor | | |
| Falcon with a 3.3 GHz processor | 897 | 618 |
| Symmetric tensor | 303264 | 2122 |
| isomorphism-based signature | | |
| scheme with a 2.4 GHz processor | | |

As shown in Table 3, as compared with the other schemes, the running time for the scheme in the embodiments of the present disclosure is improved obviously. As shown in Table 4, as compared with the other schemes, the public key length for the scheme in the embodiments of the present disclosure is remarkably reduced.

Third Embodiment

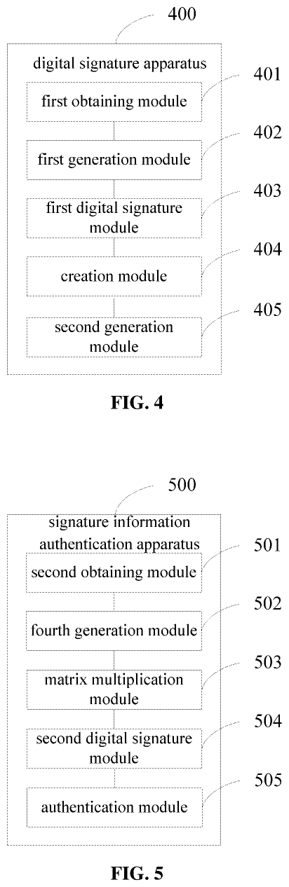

As shown in FIG. 4, the present disclosure provides in this embodiment a digital signature apparatus 400 realized by a first electronic device, which includes: a first obtaining module 401 configured to obtain a to-be-transmitted file, a private key of the first electronic device for digital signature, and first compressed data, the first compressed data being obtained through compressing a randomly-generated symmetric tensor, an order of the first symmetric tensor being greater than 2, the private key including a first invertible matrix; a first generation module 402 configured to generate L pieces of second compressed data corresponding to L second symmetric tensors in accordance with the first invertible matrix and the first compressed data, the L second symmetric tensors including the first symmetric tensor and symmetric tensors isomorphic to the first symmetric tensor, L being a positive integer greater than 1; a first digital signature module 403 configured to perform digital signature on the to-be-transmitted file in accordance with a randomly-generated second invertible matrix and the first compressed data, so as to obtain a first character string; a creation module 404 configured to create a Hash value of a root node in a Hash tree in accordance with L pieces of created data, the L pieces of created data being the L pieces of second compressed data or the L second symmetric tensors; and a second generation module 405 configured to generate signature information about the to-be-transmitted file for the first electronic device in accordance with the first character string, the first invertible matrix, the second invertible matrix, the L pieces of second compressed data and the Hash value of the root node in the Hash tree.

In a possible embodiment of the present disclosure, the second generation module 405 includes: a splicing unit configured to splice the first character string into P character strings, P being a positive integer greater than 1; a processing unit configured to perform matrix multiplication on an inverse matrix of the first invertible matrix and the second invertible matrix in accordance with the P character strings, so as to generate a target matrix; a selection unit configured to select N pieces of second compressed data from the L pieces of second compressed data in accordance with the P character strings, N being a positive integer; and a determination unit configured to determine an authentication path corresponding to each piece of second compressed data in the N pieces of second compressed data in accordance with the Hash value of the root node in the Hash tree and the second compressed data, the authentication path being an authentication path of the created data relative to the root node in the Hash tree. The signature information includes the P character strings, the target matrix, the N pieces of second compressed data, and authentication paths corresponding to the N pieces of second compressed data.

In a possible embodiment of the present disclosure, the N pieces of second compressed data include target compressed data, and the target compressed data is any compressed data in the N pieces of second compressed data. The determination unit is specifically configured to determine a target Hash value of each node between a leaf node in the Hash tree corresponding to target data and the root node in accordance with a Hash value of the leaf node in the Hash tree corresponding to the target data and the Hash value of the root node. The target data is the created data corresponding to the target compressed data, and an authentication path of the target data relative to the root node in the Hash tree includes the target Hash value and a position of each node between the leaf node in the Hash tree corresponding to the target data and the root node.

In a possible embodiment of the present disclosure, the first digital signature module 403 is specifically configured to: generate first signature data in accordance with the first compressed data and the randomly-generated second invertible matrix, the first signature data being a third symmetric tensor isomorphic to the first symmetric tensor or third compressed data corresponding to the third symmetric tensor; and perform the digital signature on the to-be-transmitted file in accordance with the first signature data, so as to obtain the first character string.

In a possible embodiment of the present disclosure, the creation module 404 is specifically configured to: create a Hash value of a leaf node in the Hash tree in accordance with the L pieces of created data and a randomly-generated first target character string; and create Hash values of nodes in the Hash tree other than the leaf node in accordance with the Hash value of the leaf node in the Hash tree and the first target character string, the nodes including the root node in the Hash tree.

In a possible embodiment of the present disclosure, the digital signature apparatus further includes: a third generation module configured to generate a public key corresponding to the private key, the public key including the first target character string and the Hash value of the root node in the Hash tree; and a publication module configured to enable the public key to be publicly available.

The digital signature apparatus 400 in this embodiment of the present disclosure is capable of implementing the above-mentioned digital signature method with a same beneficial effect, which will not be particularly defined herein.

Fourth Embodiment

As shown in FIG. 5, the present disclosure provides in this embodiment a signature information authentication apparatus 500 realized by a second electronic device, which includes: a second obtaining module 501 configured to obtain a to-be-transmitted file, signature information about the to-be-transmitted file, and a public key for authenticating the signature information for the second electronic device, the public key corresponding to a private key associated with the signature information, the public key including a Hash value of a root node in a Hash tree, the signature information including N pieces of second compressed data corresponding to N second symmetric tensors and authentication paths of N pieces of created data relative to the root node in the Hash tree, each piece of created data being one piece of second compressed data or a second symmetric tensor corresponding to one piece of second compressed data; a fourth generation module 502 configured to generate Q second target character strings in accordance with the N pieces of second compressed data and the authentication paths, Q being a positive integer; a matrix multiplication module 503 configured to, in the case that the Hash value of the root node in the Hash tree is identical to each second target character string, perform matrix multiplication on the signature information and the N second symmetric tensors in accordance with the N pieces of second compressed data, so as to generate second signature data, the second signature data being a fourth symmetric tensor isomorphic to the N second symmetric tensors or fourth compressed data corresponding to the fourth symmetric tensor; a second digital signature module 504 configured to perform digital signature on the to-be-transmitted file in accordance with the second signature data, so as to obtain a second character string; and an authentication module 505 configured to authenticate the signature information in accordance with the second character string.

In a possible embodiment of the present disclosure, a type of the second signature data corresponds to a type of the first signature data, the first signature data is a third symmetric tensor isomorphic to a first symmetric tensor or third compressed data corresponding to the third symmetric tensor, and the first signature data is used to perform the digital signature on the to-be-transmitted file.

In a possible embodiment of the present disclosure, the signature information includes P character strings, where P is a positive integer greater than 1. The authentication module 505 is specifically configured to: splice the second character string into K character strings, P being equal to K; and in the case that the P character strings are identical to the K character strings respectively, determine that the signature information has been authenticated successfully, or in the case that a third target character string in the P character strings is different from a fourth target character string in the K character strings, determine that the signature information has been authenticated unsuccessfully. A position of the third target character string in the P character strings corresponds to a position of the fourth target character string in the K character strings, and the third target character string is any character string in the P character strings.

The signature information authentication apparatus 400 in this embodiment of the present disclosure is capable of implementing the above-mentioned signature information authentication method with a same beneficial effect, which will not be particularly defined herein.

The collection, storage, usage, processing, transmission, supply and publication of personal information involved in the embodiments of the present disclosure comply with relevant laws and regulations, and do not violate the principle of the public order.

The present disclosure further provides in some embodiments an electronic device, a computer-readable storage medium and a computer program product.

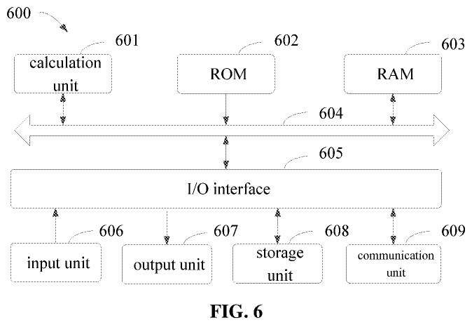

FIG. 6 is a schematic block diagram of an exemplary electronic device 600 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 6, the electronic device 600 includes a computing unit 601 configured to execute various processing in accordance with computer programs stored in a Read Only Memory (ROM) 602 or computer programs loaded into a Random Access Memory (RAM) 603 via a storage unit 608. Various programs and data desired for the operation of the electronic device 600 may also be stored in the RAM 603. The computing unit 601, the ROM 602 and the RAM 603 may be connected to each other via a bus 604. In addition, an input/output (I/O) interface 605 may also be connected to the bus 604.

Multiple components in the electronic device 600 are connected to the I/O interface 605. The multiple components include: an input unit 606, e.g., a keyboard, a mouse and the like; an output unit 606, e.g., a variety of displays, loudspeakers, and the like; a storage unit 608, e.g., a magnetic disk, an optic disk and the like; and a communication unit 609, e.g., a network card, a modem, a wireless transceiver, and the like. The communication unit 609 allows the electronic device 600 to exchange information/data with other devices through a computer network and/or other telecommunication networks, such as the Internet.

The computing unit 601 may be any general purpose and/or special purpose processing components having a processing and computing capability. Some examples of the computing unit 601 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 601 carries out the aforementioned methods and processes, e.g., the digital signature method or the signature information authentication method. For example, in some embodiments of the present disclosure, the digital signature method or the signature information authentication method may be implemented as a computer software program tangibly embodied in a machine readable medium such as the storage unit 608. In some embodiments of the present disclosure, all or a part of the computer program may be loaded and/or installed on the electronic device 600 through the ROM 602 and/or the communication unit 609. When the computer program is loaded into the RAM 603 and executed by the computing unit 601, one or more steps of the foregoing digital signature method or the signature information authentication method may be implemented. Optionally, in some other embodiments of the present disclosure, the computing unit 601 may be configured in any other suitable manner (e.g., by means of firmware) to implement the digital signature method or the signature information authentication method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, feedback provided to the user may be any manner of sensory feedback (e.g., visual feedback, auditory feedback, or tactile feedback), and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be appreciated that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A digital signature method realized by a first electronic device, the data signature method comprising:
obtaining a to-be-transmitted file, a private key of the first electronic device for digital signature, and first compressed data, the first compressed data being obtained through compressing a randomly-generated symmetric tensor, an order of the first symmetric tensor being greater than 2, the private key comprising a first invertible matrix;
generating L pieces of second compressed data corresponding to L second symmetric tensors in accordance with the first invertible matrix and the first compressed data, the L second symmetric tensors comprising the first symmetric tensor and symmetric tensors isomorphic to the first symmetric tensor, L being a positive integer greater than 1;
performing a digital signature on the to-be-transmitted file in accordance with a randomly-generated second invertible matrix and the first compressed data, so as to obtain a first character string;
creating a Hash value of a root node in a Hash tree in accordance with L pieces of created data, the L pieces of created data being the L pieces of second compressed data or the L second symmetric tensors; and
generating signature information about the to-be-transmitted file for the first electronic device in accordance with the first character string, the first invertible matrix, the second invertible matrix, the L pieces of second compressed data and the Hash value of the root node in the Hash tree.

2. The data signature method according to claim 1, wherein generating the signature information about the to-be-transmitted file for the first electronic device comprises:
splicing the first character string into P character strings, P being a positive integer greater than 1;
performing matrix multiplication on an inverse matrix of the first invertible matrix and the second invertible matrix in accordance with the P character strings, so as to generate a target matrix;
selecting N pieces of second compressed data from the L pieces of second compressed data in accordance with the P character strings, N being a positive integer; and
determining an authentication path corresponding to each piece of second compressed data in the N pieces of second compressed data in accordance with the Hash value of the root node in the Hash tree and the second compressed data, the authentication path being an authentication path of the created data relative to the root node in the Hash tree,
wherein the signature information comprises the P character strings, the target matrix, the N pieces of second compressed data, and authentication paths corresponding to the N pieces of second compressed data.

3. The digital signature method according to claim 2, wherein:
the N pieces of second compressed data comprise target compressed data, and the target compressed data is any compressed data in the N pieces of second compressed data;
the determining the authentication path corresponding to each piece of second compressed data in the N pieces of second compressed data in accordance with the Hash value of the root node in the Hash tree and the second compressed data comprises determining a target Hash value of each node between a leaf node in the Hash tree corresponding to target data and the root node in accordance with a Hash value of the leaf node in the Hash tree corresponding to the target data and the Hash value of the root node; and
the target data is the created data corresponding to the target compressed data, and an authentication path of the target data relative to the root node in the Hash tree comprises the target Hash value and a position of each node between the leaf node in the Hash tree corresponding to the target data and the root node.

4. The digital signature method according to claim 1, wherein performing the digital signature on the to-be-transmitted file in accordance with the randomly-generated second invertible matrix and the first compressed data so as to obtain the first character string comprises:
generating first signature data in accordance with the first compressed data and the randomly-generated second invertible matrix, the first signature data being a third symmetric tensor isomorphic to the first symmetric tensor or third compressed data corresponding to the third symmetric tensor; and
performing the digital signature on the to-be-transmitted file in accordance with the first signature data to obtain the first character string.

5. The digital signature method according to claim 1, wherein creating the Hash value of the root node in the Hash tree in accordance with the L pieces of created data comprises:
creating a Hash value of a leaf node in the Hash tree in accordance with the L pieces of created data and a randomly-generated first target character string; and
creating Hash values of nodes in the Hash tree other than the leaf node in accordance with the Hash value of the leaf node in the Hash tree and the first target character string, wherein the nodes in the Hash tree other than the leaf node comprise the root node in the Hash tree.

6. The digital signature method according to claim 5, wherein prior to obtaining the to-be-transmitted file, the private key for the digital signature for the first electronic device and the first compressed data, the digital signature method further comprises:
generating a public key corresponding to the private key, the public key comprising the first target character string and the Hash value of the root node in the Hash tree; and
enabling the public key to be publicly available.

7. A signature information authentication method realized by a second electronic device, the signature information authentication method comprising:
obtaining a to-be-transmitted file, signature information about the to-be-transmitted file, and a public key for authenticating the signature information for the second electronic device, the public key corresponding to a private key associated with the signature information, the public key comprising a Hash value of a root node in a Hash tree, the signature information comprising N pieces of second compressed data corresponding to N second symmetric tensors and authentication paths of N pieces of created data relative to the root node in the Hash tree, each piece of created data being one piece of second compressed data or a second symmetric tensor corresponding to one piece of second compressed data;
generating Q second target character strings in accordance with the N pieces of second compressed data and the authentication paths, Q being a positive integer;
in the case that the Hash value of the root node in the Hash tree is identical to each second target character string, performing matrix multiplication on the signature information and the N second symmetric tensors in accordance with the N pieces of second compressed data to generate second signature data, the second signature data being a fourth symmetric tensor isomorphic to the N second symmetric tensors or fourth compressed data corresponding to the fourth symmetric tensor;
performing digital signature on the to-be-transmitted file in accordance with the second signature data, so as to obtain a second character string; and
authenticating the signature information in accordance with the second character string.

8. The signature information authentication method according to claim 7, wherein a type of the second signature data corresponds to a type of the first signature data, the first signature data is a third symmetric tensor isomorphic to a first symmetric tensor or third compressed data corresponding to the third symmetric tensor, and the first signature data is used to perform the digital signature on the to-be-transmitted file.

9. The signature information authentication method according to claim 7, wherein:
the signature information comprises P character strings, where P is a positive integer greater than 1;
authenticating the signature information in accordance with the second character string comprises
splicing the second character string into K character strings, P being equal to K, and
in the case that the P character strings are identical to the K character strings respectively, determining that the signature information has been authenticated successfully, or in the case that a third target character string in the P character strings is different from a fourth target character string in the K character strings, determining that the signature information has been authenticated unsuccessfully; and
a position of the third target character string in the P character strings corresponds to a position of the fourth target character string in the K character strings, and the third target character string is any character string in the P character strings.

10. An electronic device, comprising at least one processor, and a memory in communication with the at least one processor, wherein the memory is configured to store therein at least one instruction to be executed by the at least one processor, and the at least one instruction is executed by the at least one processor so as to implement a digital signature method, which comprises:
obtaining a to-be-transmitted file, a private key of the first electronic device for digital signature, and first compressed data, the first compressed data being obtained through compressing a randomly-generated symmetric tensor, an order of the first symmetric tensor being greater than 2, the private key comprising a first invertible matrix;
generating L pieces of second compressed data corresponding to L second symmetric tensors in accordance with the first invertible matrix and the first compressed data, the L second symmetric tensors comprising the first symmetric tensor and symmetric tensors isomorphic to the first symmetric tensor, L being a positive integer greater than 1;
performing a digital signature on the to-be-transmitted file in accordance with a randomly-generated second invertible matrix and the first compressed data, so as to obtain a first character string;
creating a Hash value of a root node in a Hash tree in accordance with L pieces of created data, the L pieces of created data being the L pieces of second compressed data or the L second symmetric tensors; and
generating signature information about the to-be-transmitted file for the first electronic device in accordance with the first character string, the first invertible matrix, the second invertible matrix, the L pieces of second compressed data and the Hash value of the root node in the Hash tree.

11. The electronic device according to claim 10, wherein generating the signature information about the to-be-transmitted file comprises:
splicing the first character string into P character strings, P being a positive integer greater than 1;
performing matrix multiplication on an inverse matrix of the first invertible matrix and the second invertible matrix in accordance with the P character strings, so as to generate a target matrix;
selecting N pieces of second compressed data from the L pieces of second compressed data in accordance with the P character strings, N being a positive integer; and
determining an authentication path corresponding to each piece of second compressed data in the N pieces of second compressed data in accordance with the Hash value of the root node in the Hash tree and the second compressed data, the authentication path being an authentication path of the created data relative to the root node in the Hash tree,
wherein the signature information comprises the P character strings, the target matrix, the N pieces of second compressed data, and authentication paths corresponding to the N pieces of second compressed data.

12. The electronic device according to claim 11, wherein:
the N pieces of second compressed data comprise target compressed data, and the target compressed data is any compressed data in the N pieces of second compressed data;
determining the authentication path corresponding to each piece of second compressed data in the N pieces of second compressed data in accordance with the Hash value of the root node in the Hash tree and the second compressed data comprises
determining a target Hash value of each node between a leaf node in the Hash tree corresponding to target data and the root node in accordance with a Hash value of the leaf node in the Hash tree corresponding to the target data and the Hash value of the root node; and
the target data is the created data corresponding to the target compressed data, and an authentication path of the target data relative to the root node in the Hash tree comprises the target Hash value and a position of each node between the leaf node in the Hash tree corresponding to the target data and the root node.

13. The electronic device according to claim 10, wherein performing the digital signature on the to-be-transmitted file in accordance with the randomly-generated second invertible matrix and the first compressed data so as to obtain the first character string comprises:
generating first signature data in accordance with the first compressed data and the randomly-generated second invertible matrix, the first signature data being a third symmetric tensor isomorphic to the first symmetric tensor or third compressed data corresponding to the third symmetric tensor; and
performing the digital signature on the to-be-transmitted file in accordance with the first signature data, so as to obtain the first character string.

14. The electronic device according to claim 10, wherein creating the Hash value of the root node in the Hash tree in accordance with the L pieces of created data comprises:
creating a Hash value of a leaf node in the Hash tree in accordance with the L pieces of created data and a randomly-generated first target character string; and
creating Hash values of nodes in the Hash tree other than the leaf node in accordance with the Hash value of the leaf node in the Hash tree and the first target character string, wherein the nodes in the Hash tree other than the leaf node comprise the root node in the Hash tree.

15. The electronic device according to claim 14, wherein prior to obtaining the to-be-transmitted file, the private key for the digital signature for the first electronic device and the first compressed data, the digital signature method further comprises:
generating a public key corresponding to the private key, the public key comprising the first target character string and the Hash value of the root node in the Hash tree; and
enabling the public key to be publicly available.

16. An electronic device, comprising at least one processor, and a memory in communication with the at least one processor, wherein the memory is configured to store therein an instruction to be executed by the at least one processor, and the instruction is executed by the at least one processor so as to implement the signature information authentication method according to claim 7.

17. The electronic device according to claim 16, wherein a type of the second signature data corresponds to a type of the first signature data, the first signature data is a third symmetric tensor isomorphic to a first symmetric tensor or third compressed data corresponding to the third symmetric tensor, and the first signature data is used to perform the digital signature on the to-be-transmitted file.

18. The electronic device according to claim 16, wherein:
the signature information comprises P character strings, where P is a positive integer greater than 1;
authenticating the signature information in accordance with the second character string comprises
splicing the second character string into K character strings, P being equal to K; and
in the case that the P character strings are identical to the K character strings respectively, determining that the signature information has been authenticated successfully, or in the case that a third target character string in the P character strings is different from a fourth target character string in the K character strings, determining that the signature information has been authenticated unsuccessfully; and
a position of the third target character string in the P character strings corresponds to a position of the fourth target character string in the K character strings, and the third target character string is any character string in the P character strings.

19. A non-transitory computer-readable storage medium storing therein at least one computer instruction, wherein the at least one computer instruction is executed by a computer so as to implement the digital signature method according to claim 1.

20. A non-transitory computer-readable storage medium storing therein a computer instruction, wherein the at least one computer instruction is executed by a computer so as to implement the signature information authentication method according to claim 7.
